(19) United States
(12) Patent Application Publication
(10) Pub. No.: US 2005/0072175 A1
(43) Pub. Date: Apr. 7, 2005

(54) Air conditioner and truck equipped with same

(76) Inventors: Tadashi Umeo, Nagoya-city (JP); Yukio Ueno, Toyokawa-city (JP); Shigenori Hirao, Toyohashi-city (JP)

Correspondence Address: HARNESS, DICKEY & PIERCE, P.L.C., P.O. BOX 828, BLOOMFIELD HILLS, MI, 48303, US

(21) Appl. No.: 10/952,521

(22) Filed: Sep. 28, 2004

(30) Foreign Application Priority Data
Oct. 2, 2003 (JP) 2003-344889
Aug. 20, 2004 (JP) 2004-241152

(51) Int. Cl. F25D 5/00; F25B 27/00; B60H 1/32

(52) U.S. Cl. 62/236; 62/244

(57) ABSTRACT

A vehicle air conditioner includes a refrigeration cycle system that includes a compressor for compressing refrigerant, a condenser, a pressure reducing means, and an evaporator, and an air conditioning unit, which operates the refrigeration cycle unit, for air-conditioning air in a passenger compartment. In the air conditioner, the compressor is a motor driven compressor driven by one of a battery that is charged by a generator driven by a vehicle power source and an outside commercial electric power source. The air conditioning unit is an integrated unit of the refrigeration cycle system that includes the motor driven compressor disposed on a vehicle roof.

### CROSS REFERENCE TO RELATED APPLICATION

The present application is based on and claims priority from Japanese Patent Applications: 2003-344889, filed Oct. 2, 2003; and 2004-241152, filed Aug. 20, 2004, the contents of which are incorporated herein by reference.

### BACKGROUND OF THE INVENTION

1. Field of the Invention

The present invention relates to an air conditioner that is composed of a refrigeration cycle system and a truck that is equipped with such an air conditioner and particularly relates to an air conditioning unit that can operate even when a vehicle power source stops due to stopping of the vehicle.

2. Description of the Related Art

When a vehicle such as a truck stops for loading or unloading, the engine of the vehicle is required to stop by a regulation of engine idling. However, when the vehicle engine stops, the refrigeration cycle system that is powered by the vehicle engine necessarily stops, resulting in no air conditioning in the compartment of the vehicle. JP-A2001-219734 discloses a cool storage type air conditioner for a vehicle that includes a cool storage cooler that includes cool storage material as well as a refrigeration cycle system composed of an engine driven compressor, a condenser, decompressing means and an evaporator. The cool storage cooler is mounted in a cool storage unit, which is set in parallel with the evaporator and is disposed near a driver seat. The above cool storage unit makes the cool storage material cooled by the refrigeration cycle system while the vehicle engine is running and supplies cooling air cooled by the cool storage cooler unit while both the vehicle and the engine stop.

According to the disclosure of JP-A2001-219734, a separate cool storage unit that includes the cool storage cooler beside the air conditioning unit that includes the evaporator for air conditioning the passenger compartment. Therefore, the total size of the air conditioner becomes so large that more space of the passenger compartment is necessary for the air conditioner. Further, the number of components of the air conditioner increases to increase the cost thereof.

In this vehicle air conditioner, an air conditioning unit that includes an evaporator is mounted in the passenger compartment while a compressor is mounted in the engine compartment. They are connected by pipes to form a refrigeration cycle system. If the air condition unit is mounted at a vehicle roof, the pipes become longer and more expensive than those when it is mounted in the passenger compartment.

Therefore, an object of the invention is to provide a compact and inexpensive vehicle air conditioner that has a refrigeration cycle system of integrated components mounted at a vehicle roof and a truck mounting the same. Therefore, the air conditioner according to the invention can make effective use of the space of the passenger compartment. This provides a truck that mounts the above-described air conditioner.

### SUMMARY OF THE INVENTION

In order to attain the object according to one feature of the invention, a vehicle air conditioner includes a refrigeration cycle system including a compressor for compressing refrigerant, a condenser, a pressure reducing means, and an evaporator, and an air conditioning unit, which operates the refrigeration cycle unit, for air-conditioning air in a passenger compartment. In the above vehicle air conditioner, the compressor is a motor driven compressor driven by one of a battery that is charged by a generator driven by a vehicle power source and an outside commercial electric power source. Further, the air conditioning unit is an integrated unit of the refrigeration cycle system that includes the motor driven compressor disposed on a vehicle roof.

Therefore, with the motor driven compressor that is driven by a battery or an outside commercial electric power source, a passenger room can be air-conditioned even when a vehicle and the vehicle power source stop. This vehicle air conditioner can have a more compact and less expensive air conditioning unit that includes simpler refrigeration cycle system therein than a conventional type that has a cool storage cooler.

Further, the air conditioning unit that integrally includes a refrigeration cycle system that has a motor driven compressor is disposed on a vehicle roof, so that less piping members for connecting the refrigeration cycle are necessary than the conventional type that has the compressor in the engine compartment. Therefore, the air condition unit can be mounted easier, and variety of shapes of the piping members can be limited.

Another feature of the invention is that the motor driven compressor is driven at least one of the battery and the outside commercial electric source when the vehicle and the vehicle power source stop. Therefore, when the vehicle power source stops, the air conditioner can be operated by the battery of the outside commercial electric source. When the residual electric power of the battery is not so large, the motor driven compressor can be operated by the outside commercial electric power source. Therefore, the air conditioner can be operated without the battery at an outside facility where the outside commercial electric power source is provided with.

According to another feature of the invention, the air conditioning unit having the above feature further includes an air blow duct disposed at the vehicle roof to connect the evaporator and a passenger compartment. The above air blow duct blows air that has been cooled by the evaporator toward one of a driver's seat and another. Therefore, the air-conditioned air can be easily blown toward the passenger's seat and rear room for napping besides the driver's seat.

According to another feature of the invention, the driver's seat is a truck driver's seat, and the another is a rear room for napping disposed at the rear of the truck driver's seat. Therefore, the room for napping is air-conditioned even when the truck and the vehicle power source stop.

According to another feature of the invention, the refrigeration cycle system has a heat pump cycle in which direction of supplying refrigerant is changed when operation changes from one mode to the other between a cooling mode and a heating mode, and wherein refrigerant of high temperature and high pressure is taken into the evaporator during the heating mode. With the heat pump cycle being adopted, piping members for introducing water from a vehicle engine to a heater core disposed on the vehicle roof are not necessary, so that easier mounting of the air conditioning unit and reduction in number of parts can be attained.

According to further additional feature of the invention, a portion of the refrigerant compressed by the motor driven compressor is taken into a heating heat exchanger when the refrigeration cycle system operates. Therefore, when outside temperature is so low that defrosting is necessary, such a portion of the refrigerant is used for heating and defrosting.

According to another additional feature of the invention, the air conditioning unit includes a heating heat exchanger for heating air that has passed the evaporator by vehicle engine coolant. This helps for a while after the vehicle engine stops although this can not heat the passenger compartment for a very long time.

According to another feature of the invention, a truck equipped with a vehicle air conditioner includes a refrigeration cycle system including a compressor for compressing refrigerant, a condenser, a pressure reducing means, and an evaporator and an air conditioning unit, which operates the refrigeration cycle unit, for air-conditioning air in a passenger compartment. In the truck with the above-described feature, the air conditioning unit is an integrated unit of the refrigeration cycle system disposed on a vehicle roof, and the truck has an open space in front of a passenger's seat. Therefore, the open space that has accommodated the air conditioning unit can be utilized effectively.

According to an additional feature of the invention, the truck has a windshield a portion for the passenger's seat that extends near a vehicle floor. Therefore, driver's visibility in front of the passenger's seat increases.

According to another feature of the invention, the truck includes a glass pane window between a windshield and a vehicle floor.

According to another additional feature of the invention, a reclining seat is provided for a passenger's seat and a footrest is disposed in the open space.

According to another additional feature of the invention, a folding type passenger's seat can be stored in the open space. This can reduce the cabin of the truck.

According to another feature of the invention, the truck equipped with a vehicle air conditioner includes a refrigeration cycle system including a compressor for compressing refrigerant, a condenser, a pressure reducing means, and an evaporator, and an air conditioning unit, which operates the refrigeration cycle unit, for air-conditioning air in a passenger compartment. In the truck, the air conditioning unit is an integrated unit of the refrigeration cycle system disposed on a vehicle roof. The truck has an instrument panel between a driver's seat and a passenger's seat and a multipurpose console box that is detachably fixed to the instrument panel. Therefore, the multiple purpose console box can be utilized in various ways.

According to another aspect of the invention, a vehicle air conditioner for a vehicle having a driver's seat, a passenger's seat and a vehicle roof includes an air conditioning unit including a refrigeration cycle system and air blower means, the refrigeration cycle system including a motor driven compressor for compressing refrigerant, a condenser, a pressure reducing means and an evaporator, an inverter connected to the motor driven compressor, a battery having a capacity to drive the motor driven compressor without being charged for a predetermined time period, and an input means connected to the inverter which is selectively connectable with the battery and a commercial electric power source that is available at an outside facility. In the above vehicle air conditioner, the air conditioning unit is disposed on the vehicle roof.

According to an additional feature of the invention, the blower means includes an air blow duct disposed at the vehicle roof to connect the evaporator and a passenger compartment to blow air that is cooled by the evaporator toward one of a driver's seat and another. The above vehicle air conditioner may further include a heating heat exchanger and a valve for selectively connecting the heating heat exchanger to the motor driven compressor. Therefore, a portion of the refrigerant compressed by the motor driven compressor is selectively taken into the heating heat exchanger when the refrigeration cycle system operates.

### BRIEF DESCRIPTION OF THE DRAWINGS

Other objects, features and characteristics of the present invention as well as the functions of related parts of the present invention will become clear from a study of the following detailed description, the appended claims and the drawings. In the drawings:

FIG. 1 is a schematic diagram illustrating the overall structure of an air conditioning unit of a vehicle air conditioner according to the first embodiment of the invention;

FIG. 2 is a schematic diagram illustrating an air blow duct of the air conditioning unit mounted on a roof of a vehicle;

FIG. 3A and FIG. 3B are schematic diagrams illustrating the overall structure of an air conditioning unit of a vehicle air conditioner according to the second embodiment of the invention;

FIG. 4A is a schematic diagram illustrating a truck that is equipped with the air conditioning unit according to the third embodiment of the invention that is mounted in the passenger compartment of the truck, and

FIG. 4B is a schematic diagram illustrating a truck that is equipped with the air conditioning unit according to the third embodiment of the invention that is mounted on the roof of the truck.

FIG. 5 is a schematic diagram illustrating a truck according to the fourth embodiment of the invention;

FIG. 6 is a schematic diagram illustrating a modified example of the truck 1 according to the fourth embodiment of the invention;

FIGS. 7A and 7B are schematic diagrams illustrating structure of a multi-purpose console box; and

FIG. 8 is a schematic diagram illustrating the overall structure of an air conditioning unit according to another embodiment of the invention.

### DETAILED DESCRIPTION OF THE PREFERRED EMBODIMENTS

(First Embodiment)

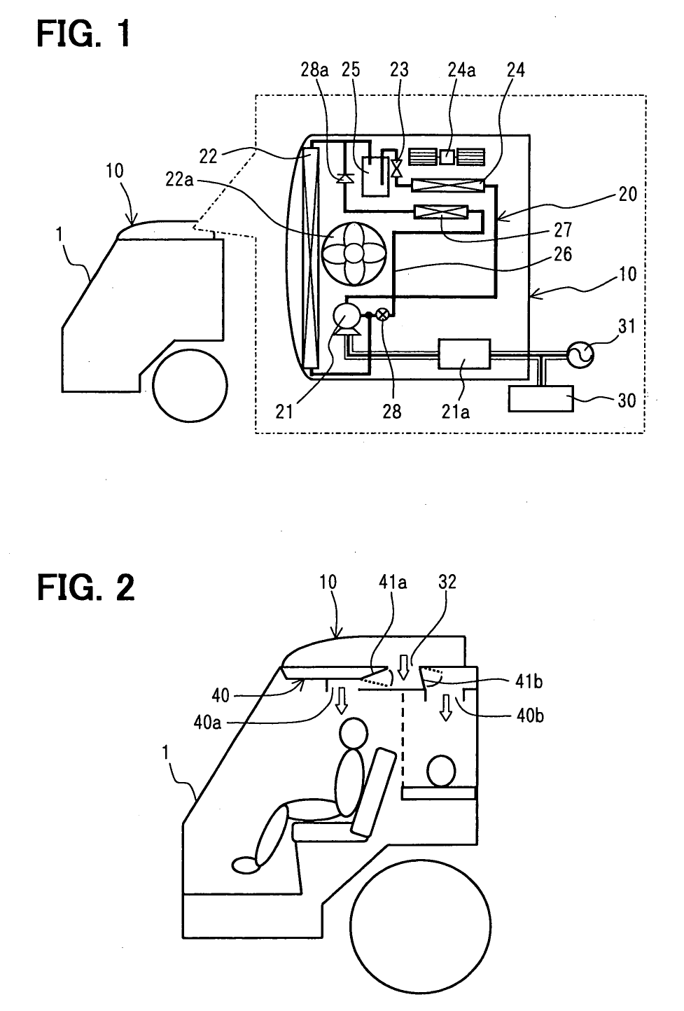

A vehicle air conditioner according to the first embodiment of the invention will be described with reference to FIG. 1 and FIG. 2. As shown in FIG. 1, an air conditioning unit 10 of this embodiment accommodates a refrigeration cycle system 20 that includes a compressor 21, a condenser 22, a receiver 25, an expansion valve 23 which functions as a decompressing means, an evaporator 24, etc., and is mounted on the roof of a truck. The compressor 21 is a motor driven compressor that has a motor to compress refrigerant. The compressor 21 is electrically connected to a commercial electric power source 31 via an inverter 21a and also a battery 30 that is charged by a generator driven by a vehicle power source such as a vehicle engine or a motor, so that it can be driven either by the commercial electric power source 31 or the battery 30.

When the vehicle is running, the compressor 21 is energized via the inverter 21a by the battery 30, which is charged by the generator that is driven by the vehicle power source. When the vehicle and the vehicle power source stop, the compressor 21 is energized via the inverter 21a by the battery 30 or an outside commercial electric power source 31.

The inverter 21a controls the rotation speed of an electric motor that is included in the compressor 21. The rotation speed is controlled by a control unit (not shown) according to signals of a room temperature sensor (not shown). When the inverter 21a is energized by the outside commercial electric power source, it is connected by a power code (not shown). In this embodiment, the battery 30 is disposed in the air conditioning unit 10. The battery can be disposed in the engine compartment. In this case, less expensive parts and components can be used because the generator and the battery 30 can be connected by a power cable that has a larger diameter.

The condenser 22 condenses refrigerant gas of high temperature and pressure that is compressed by the compressor 21. The condenser 22 has a condenser fan 22a, which takes outside air into the condenser 22 for heat exchange and discharges the heated air from it. The receiver 25 is a fluid reservoir that reserves liquid refrigerant condensed by the condenser 22 and sends the liquid refrigerant to the expansion valve 23.

The expansion valve 23 decompresses the liquid refrigerant to expand and sends it to the evaporator 24. The evaporator 24 evaporates the expanded liquid refrigerant. The evaporator 24 has a blower 24a that is connected to the passenger compartment to introduce air from the passenger compartment into the evaporator for heat exchange and discharge the heat-exchanged air into the passenger compartment via an air blow duct 40. The refrigerant that is evaporated by the evaporator 24 is introduced to the compressor on the intake side thereof. In this air conditioning unit 10, various components and parts are connected by refrigerant piping to form a circulator.

The refrigeration cycle system 20 also includes a heating heat exchanger 27 that is disposed in a bypass circuit 26, which bypasses the condenser 22. The heating heat exchanger 27 is disposed in an air flow at the downstream side of the evaporator 24 to heat air conditioned air that is cooled by the evaporator 24. One end of the bypass circuit 26 is connected to a portion between the compressor 21 and the condenser 22, and the other end is connected to a portion between the condenser 22 and the receiver 25.

The bypass circuit 26 also includes a electromagnetic valve 28 for opening or closing the same and a check valve 28a. The electromagnetic valve 28 opens while the vehicle is air conditioned to introduce the high pressure refrigerant into the heating heat exchanger 27. The check valve 28a prevents condensed refrigerant from flowing from the condenser 22 to the heating heat exchanger 27 when the electromagnetic switch 28 closes.

Incidentally, the inverter 21a, the condenser fan 22a, the blower 24a and the electromagnetic switch 28 are controlled by a well-known control unit that is not shown here. Such a control unit (not shown) executes prescribed operation processes for the above-described electrical components and parts according to prescribed programs based on sensor signals from various sensors or the like and control signals from a control panel that is not shown.

At the roof of the vehicle, an air intake port (not shown) and the air blow duct 40 are formed. The air intake port and the air blow duct port 40 are connect to air conditioning unit 10 via the vehicle roof so as to connect the evaporator 24, which is disposed in the air conditioning unit 10. In other words, openings are respectively formed at the roof and the air conditioning unit 10 so that the air intake port (not shown) is connected to the upstream side of the evaporator 24. An opening 32 is formed at the air conditioning unit 10 and the roof so that the air blow duct 40 is connected to the upstream side of the air flow of the evaporator 24, as shown in FIG. 2.

The air blow duct 40 has a first air outlet 40a for the driver seat and a second air outlet 40b for a rear room for taking a nap at the end thereof. The first air outlet 40a and the second air outlet 40b respectively have first and second doors 41a, 41b at the upstream side of the air outlets 40a, 40b.

The first door 41a and the second door 41b are air control doors that cooperatively control air flow amount by an actuator (not shown). For instance, when the air flow amount blowing to the driver's seat is 100%, the second door 41b is closed while the first door 41a is fully opened. On the other hand, the first door 41a is closed while the second door is fully opened when the air flow amount blowing to the rear room for napping is 100%. When the air flow amount for the rear room of napping is 50%, both the first door 41a and the second door 41b are controlled to open at a rate of 50%. It is possible to provide a third door for the passenger's seat in addition to the first and second doors 40a, 40b. In this case, the air blow amount for the driver's seat, the passenger's seat and the rear room for napping may be separately controlled by the doors. It is also possible to control by the doors the total air blow amount for the driver's seat and passenger's seat and the air blow amount for the rear room for napping separately.

The above-described vehicle air conditioner operates as follows. When the truck is running (by the vehicle power source) and an air condition switch (not shown) is turned on, a control unit (not shown) controls the inverter 21a so that the inverter 21a can be powered by the battery 30, which is charged by an engine driven generator, to drive the compressor 21. Accordingly, the refrigerant in the refrigeration cycle system 20 circulates therein. On the other hand, air is taken into the evaporator 24 by the blower 24a, and air-conditioned air that is cooled by the evaporator 24 is blown from the first and the second air outlets 41a, 40b through the air blow duct 40. Thus, the passenger compartment of the truck is air-conditioned.

When the air condition switch is turned on while the truck and its vehicle power source stop for loading or unloading for a while, the control unit (not shown) controls the inverter 21a so that the inverter 21a can be powered by the battery 30, which was charged by the engine driven generator beforehand, to drive the compressor 21. Accordingly, the refrigerant in the refrigeration cycle system 20 circulates therein, and air-conditioning can be provided in the passenger compartment of the truck 1 as long as the charge of the battery 30 is available.

When the vehicle power source stops, the inverter 21a can be connected to an outside commercial electric power source by a power code so that the control unit (not shown) controls the inverter 21a to drive the compressor 21 for air conditioning in the passenger compartment.

If a driver wants to take a nap in the rear room with the vehicle power source being off, the inverter 21a is controlled in the same way as described above while the first and the second doors 41a, 41b are controlled so that the air blow amount for the rear room can become 100%.

When a defroster switch (not shown) is turned on in case the windshield of the truck 1 mists to such a degree that defrosting is necessary, the control unit (not shown) makes the electromagnetic switch 28 open so as to send a portion of the refrigerant to the heating heat exchanger 27. Therefore, defrosted air conditioned air can be supplied to the passenger compartment so that the mist on the windshield can be removed.

In the vehicle air conditioner according to the first embodiment of the invention, the compressor can be driven by either the battery 30 that is charged by an engine driven generator or by an outside commercial electric power source 31. Therefore, even if the vehicle power source stops, the refrigeration cycle system 20 can be operated by the charged battery 30 or an outside electric commercial electric power source 31. Thus, a compact and inexpensive air conditioning unit 10 that is composed of a more simple refrigeration cycle system 20 than the cool storage type refrigeration cycle system can be provided.

Because the air conditioning unit 10 that includes the refrigeration cycle unit with the compressor 21 together is disposed on the vehicle roof, many piping members are not necessary to compose the refrigeration cycle system 20. Therefore, the air conditioning unit 10 can be mounted in a vehicle easier than the conventional type that has the compressor 21 separately disposed in the engine compartment. In addition, it is not necessary to change the shapes of the piping members to mount the air conditioning unit 10 in a different type truck.

The compressor 21 is driven by either the battery 30 or an outside electric commercial electric power source. Therefore, even when the vehicle and the vehicle power source stop, the passenger compartment can be air conditioned. If the battery is not sufficiently charged, the compressor 21 can be driven by an outside commercial electric power source 31. Therefore, the passenger compartment can be air conditioned at an outside facility that is equipped with a commercial electric power source even when the vehicle engine stops.

The air conditioning unit 10 has the air blow duct 40 for connecting the evaporator 24 and the passenger compartment extending from the roof of the vehicle to the ceiling thereof so that the duct 40 blows the air cooled by the evaporator toward the driver's seat or another. Therefore, it is easy to blow the air toward the passenger's seat or the rear room for napping, which is disposed at the rear of the driver's room.

If the windshield mists due to low outside temperature, the air passed through the evaporator 24 is heated by the heating heat exchanger 27, which uses a portion of the refrigerant of the refrigeration cycle system, to remove the mist.

(Second Embodiment)

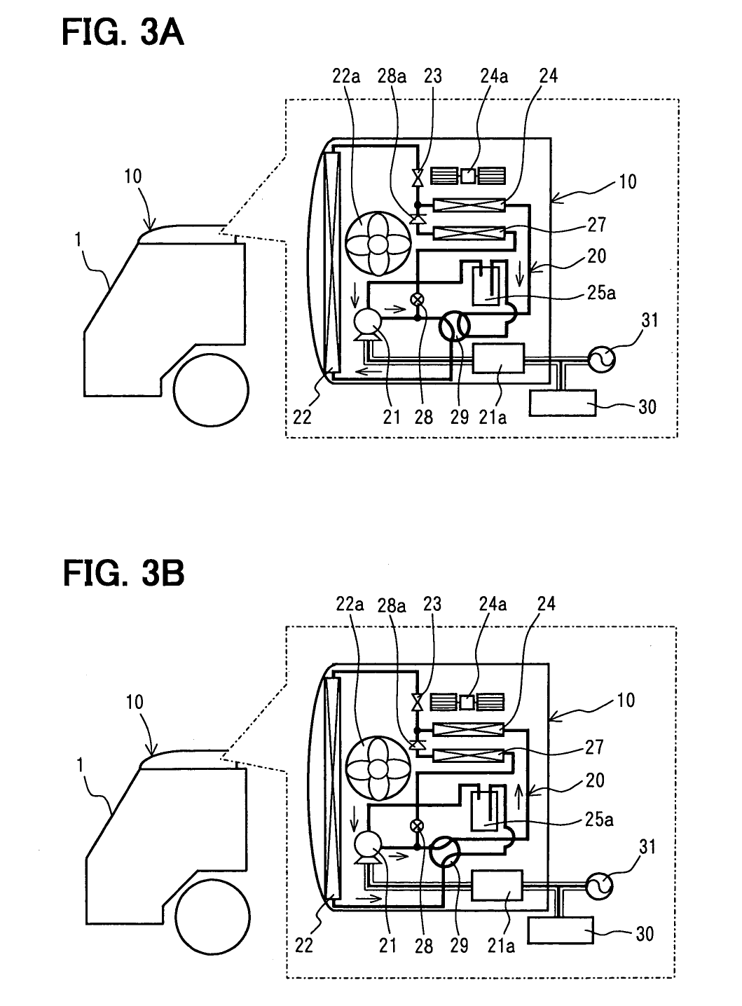

As shown in FIG. 3A and FIG. 3B, a four-way valve 29 is provided to switch the flow of the refrigerant supplied to the compressor 21, the evaporator 24 and the condenser 22. When the air conditioner operates in the cooling mode, the outlet of the compressor 21 is connected to the inlet of the condenser 22, and the inlet of the compressor 21 is connected to the outlet of the evaporator 24. On the other hand, the outlet of the compressor 21 is connected to the inlet of the evaporator 24, and the inlet of the compressor 21 is connected to the outlet of the condenser 22 when the air conditioner operates in the heating mode. In this embodiment the receiver 25 of the first embodiment is replaced by an accumulator 25a that is disposed at the inlet side of the compressor 21. This accumulator 25a has a function of separating gas from liquid so that the compressor 21 can take the refrigerant gas therein. The expansion valve 23 can be replaced by a capillary tube. Incidentally, the same reference numeral as that used in the description of the first embodiment indicates the same part or component of the first embodiment.

In the vehicle air conditioner according to the second embodiment that adopts a heat pump cycle system, no piping member for supplying engine coolant to a heater core disposed on the roof is not necessary. Therefore, the air conditioning unit 10 needs less number of parts, becomes less expensive and can be mounted in the vehicle easier than a conventional air conditioner that includes the evaporator 24 and the heater core heated by engine coolant.

(Third Embodiment)

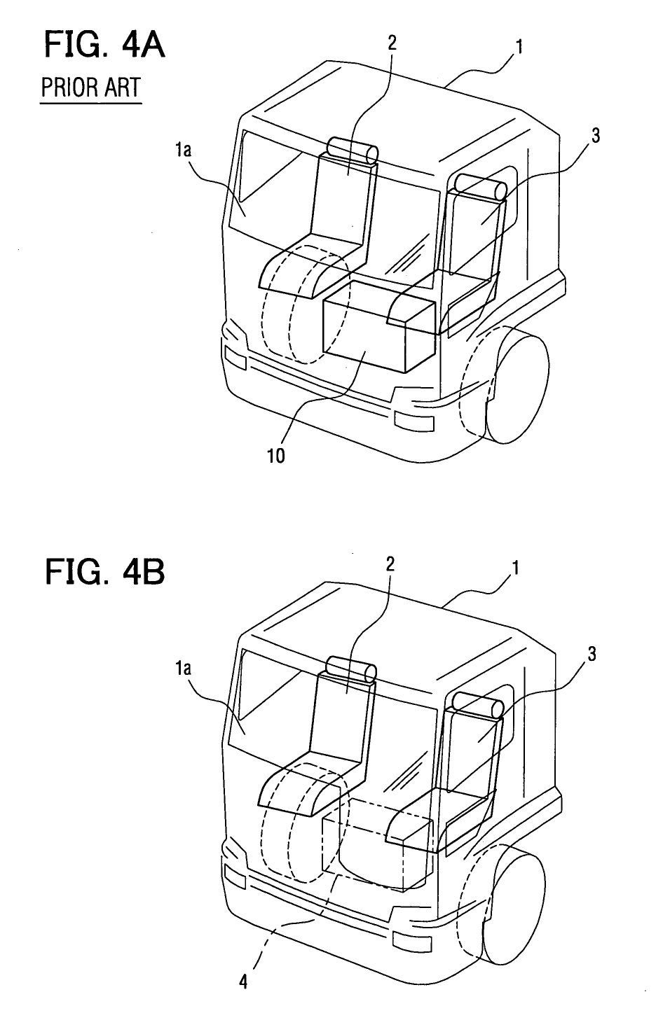

In a conventional truck 1, an air conditioning unit 10 is disposed in the passenger compartment. As shown in FIG. 4A, such an air conditioning unit 10 is in an instrument panel (not shown) disposed at the front of the body at a portion closer to the passenger seat than the driver's seat. Therefore, a space of about 60-70 liters is necessary to accommodate the air conditioning unit 10. Usually, a windshield 1a is positioned above the instrument panel that extends in the transverse direction of the truck body. In the truck according to this embodiment an open space 4 is provided instead of the air conditioning unit 10. In addition, the instrument panel is formed in a half of the width of the truck and a portion of the windshield for the passenger's seat 3 is formed to extend near the floor.

Therefore, not only the space for the passenger's seat 3 but also the visibility of an object in front of the passenger's seat 3 from the driver's seat 2 increase. As a result, a mirror for an object in front of the passenger's seat 3 can be omitted. In this embodiment, a separate window can be formed instead of the extension of the windshield for the passenger's seat 3.

(Fourth Embodiment)

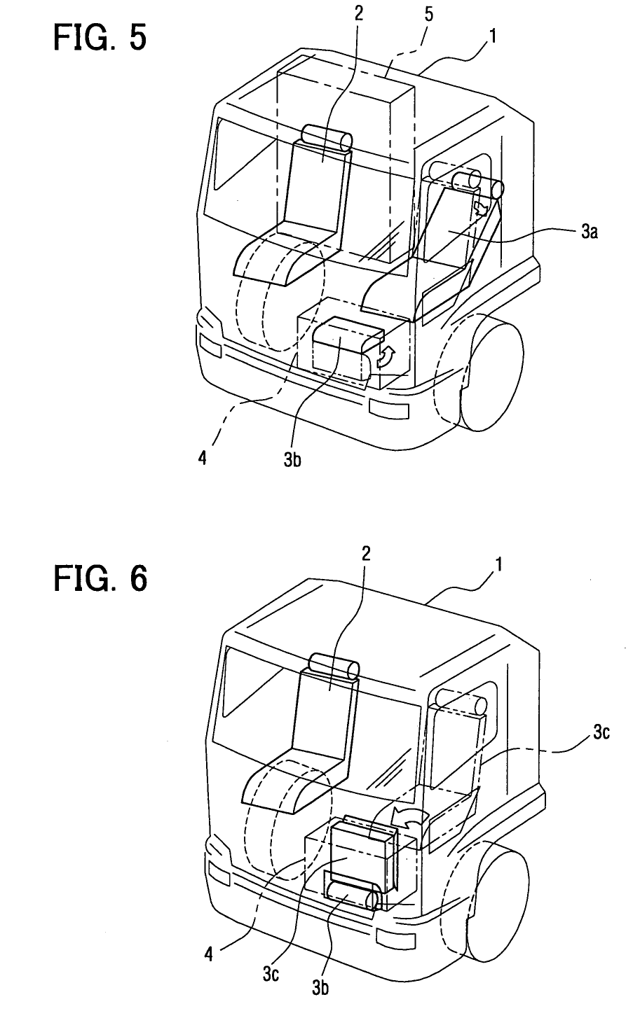

The open space 4 can be utilized in various ways. For example, the passenger's seat 3 may be a reclining seat 3a having a footrest 3b, as shown in FIG. 5. Thus, the passenger's seat 3 is served as a napping place. Therefore, the rear room for napping may become unnecessary, so that the cabin or passenger compartment can be made smaller to increase the loading space. It is also possible to provide a folding type passenger's seat 3c that can be kept in the open space 4. This provides a flat floor space whenever necessary.

(Fifth Embodiment)

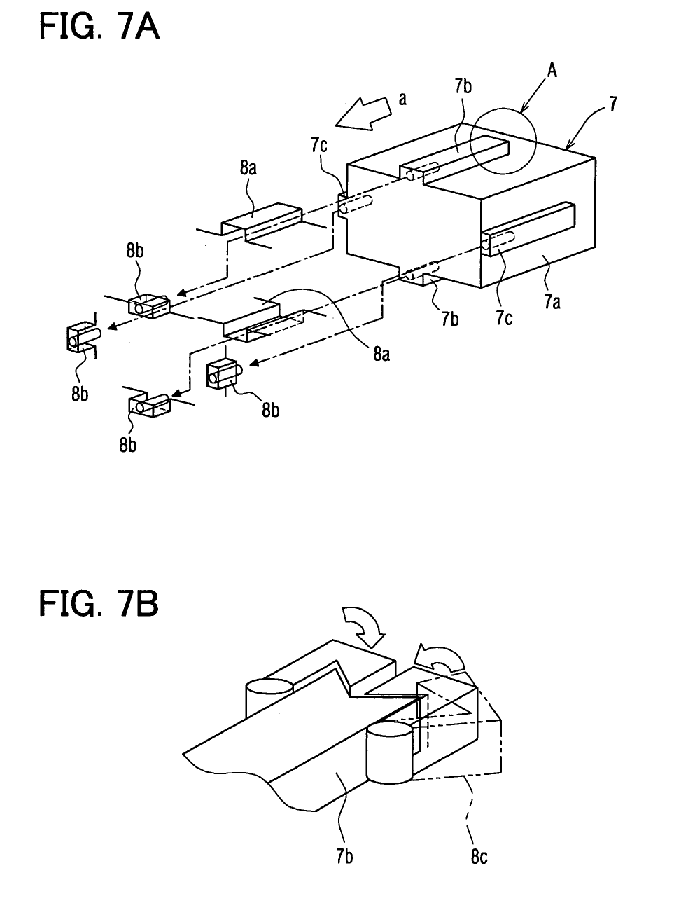

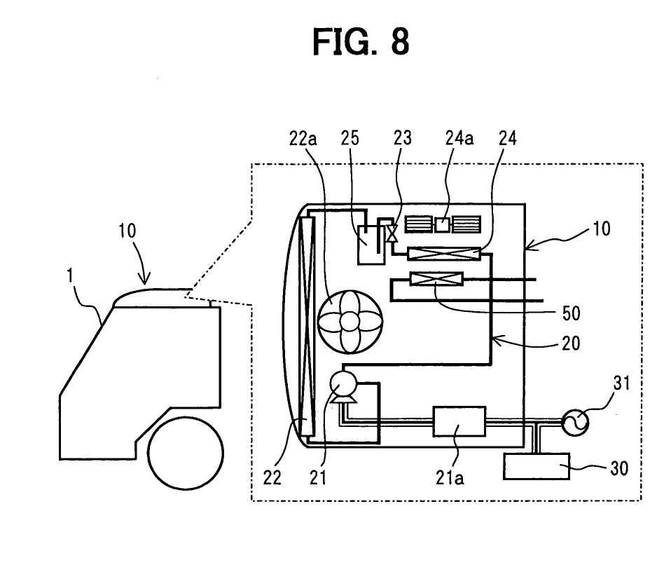

This embodiment is shown in FIG. 7A and FIG. 7B. FIG. 7A is a schematic view that illustrates the overall structure of a multipurpose console box 7, and FIG. 7B is a detailed sketch of an encircled portion A.

Reference numeral 7a indicates an external case 7a of the multipurpose console box, and reference numerals 7b and 7c indicate projecting portions. On the other hand an instrument panel (not shown) has guide rails 8a for guiding the projection portions 7a in a direction as indicated by character a and metal clamps 8b for clamping one ends of the projection portions 7b, 7c and metal lock members 8c for locking the other ends of the projection portions 7b.

As shown in FIG. 7A, the external case 7a is guided to slide along the guide rails in the direction a (toward the instrument panel) until the projection portions 7b, 7c are clumped by the metal clump 8b. Then, the projection portions 7b are locked by the metal lock members 8c, as shown in FIG. 7B.

Therefore, it is possible to select a preferable one from various types of the multipurpose console boxes and to easily mount in a truck. For example, the multipurpose console box 7 may provide boxes for dust, magazines and car-wash gear. It is also possible to change the pitch or position of the clumps 8b and the lock members 8c in case the size of the external case 7a changes.

(Other Embodiments)

It is possible to include a heating heat exchanger 50 heated by a vehicle engine as a vehicle power source to heat air that has passed the evaporator, as shown in FIG. 8. This embodiment helps for a while after the vehicle engine stops although this can not heat the passenger compartment for a very long time.

This embodiment can be also used in a one-box car such as a camper. In that case, the rear space of the vehicle can be air-conditioned after the engine stops.

In the foregoing description of the present invention, the invention has been disclosed with reference to specific embodiments thereof. It will, however, be evident that various modifications and changes may be made to the specific embodiments of the present invention without departing from the scope of the invention as set forth in the appended claims. Accordingly, the description of the present invention is to be regarded in an illustrative, rather than a restrictive, sense.

1. A vehicle air conditioner comprising:
a refrigeration cycle system including a compressor for compressing refrigerant, a condenser, a pressure reducing means, and an evaporator; and
an air conditioning unit, which operates the refrigeration cycle unit, for air-conditioning air in a passenger compartment;
wherein said compressor is a motor driven compressor driven by one of a battery that is charged by a generator driven by a vehicle power source and an outside commercial electric power source, and
wherein said air conditioning unit is an integrated unit of said refrigeration cycle system that includes said motor driven compressor disposed on a vehicle roof.

2. The vehicle air conditioner according to claim 1,
wherein said motor driven compressor is driven at least one of said battery and said outside commercial electric source when the vehicle and said vehicle power source stop.

3. The vehicle air conditioner according to claim 1,
wherein said air conditioning unit includes an air blow duct disposed at the vehicle roof to connect said evaporator and a passenger compartment, and
wherein said air blow duct blows air cooled by said evaporator toward one of a driver's seat and another.

4. The vehicle air conditioner according to claim 3,
said driver's seat is a truck driver's seat, and said another is a rear room for napping disposed at the rear of said truck driver's seat.

5. The vehicle air conditioner according to claim 1,
wherein said refrigeration cycle system has a heat pump cycle in which direction of supplying refrigerant is changed when operation changes from one mode to the other between a cooling mode and a heating mode, and wherein refrigerant of high temperature and high pressure is taken into said evaporator during the heating mode.

6. The vehicle air conditioner according to claim 1,
wherein a portion of the refrigerant compressed by said motor driven compressor is taken into a heating heat exchanger when said refrigeration cycle system operates.

7. The vehicle air conditioner according to any one of claims 1,
wherein said air conditioning unit includes a heating heat exchanger for heating air that has passed said evaporator by vehicle engine coolant.

8. A truck equipped with a vehicle air conditioner said air conditioner comprising:
a refrigeration cycle system including a compressor for compressing refrigerant, a condenser, a pressure reducing means, and an evaporator; and
an air conditioning unit, which operates the refrigeration cycle unit, for air-conditioning air in a passenger compartment;
wherein said air conditioning unit is an integrated unit of said refrigeration cycle system disposed on a vehicle roof; and
wherein said truck has an open space in front of a passenger's seat.

9. The truck according to claim 8,
wherein said truck has a windshield a portion for the passenger's seat that extends near a vehicle floor.

10. The truck according to claim 8 further comprising a glass pane window between a windshield and a vehicle floor.

11. The truck according to claim 8 comprising a reclining seat for a passenger's seat and a footrest disposed in said open space.

12. The truck according to claim 8 comprising a folding type passenger's seat that can be stored in said open space.

13. A truck equipped with a vehicle air conditioner said air conditioner comprising:
a refrigeration cycle system including a compressor for compressing refrigerant, a condenser, a pressure reducing means, and an evaporator; and
an air conditioning unit, which operates the refrigeration cycle unit, for air-conditioning air in a passenger compartment;
wherein said air conditioning unit is an integrated unit of said refrigeration cycle system disposed on a vehicle roof; and
wherein said truck has an instrument panel between a driver's seat and a passenger's seat and a multipurpose console box that is detachably fixed to said instrument panel.

14. A vehicle air conditioner for a vehicle having a driver's seat, a passenger's seat and a vehicle roof, said air conditioner comprising:
an air conditioning unit including a refrigeration cycle system and air blower means, said refrigeration cycle system including a motor driven compressor for compressing refrigerant, a condenser, a pressure reducing means and an evaporator;
an inverter connected to said motor driven compressor;
a battery having a capacity to drive said motor driven compressor without being charged for a predetermined time period; and
an input means connected to said inverter which is selectively connectable with said battery and a commercial electric power source that is available at an outside facility;
wherein said air conditioning unit is disposed on the vehicle roof.

15. The vehicle air conditioner according to claim 14,
wherein said blower means includes an air blow duct disposed at the vehicle roof to connect said evaporator and a passenger compartment to blow air that is cooled by said evaporator toward one of a driver's seat and another.

16. The vehicle air conditioner according to claim 14, further comprising a heating heat exchanger and a valve for selectively connecting said heating heat exchanger to said motor driven compressor,
wherein a portion of the refrigerant compressed by said motor driven compressor is selectively taken into said heating heat exchanger when said refrigeration cycle system operates.
